(19) United States
(12) Patent Application Publication
(10) Pub. No.: US 2003/0107749 A1
(43) Pub. Date: Jun. 12, 2003

(54) In-vehicle printing system

(76) Inventor: Rene Charles Aquilina, Milford, MI (US)

Correspondence Address: HEWLETT-PACKARD COMPANY, Intellectual Property Administration, P.O. Box 272400, Fort Collins, CO, 80527-2400, US

(21) Appl. No.: 10/016,256

(22) Filed: Dec. 10, 2001

(51) Int. Cl. B41J 1/00; G06F 15/00

(52) U.S. Cl. 358/1.1

(57) ABSTRACT

An in-vehicle printing system that provides an in-vehicle mounted printer operably connected to a host-computing device such as the vehicle's telematics system or a personal computer.

### TECHNICAL FIELD

This invention relates to a printer embedded in a vehicle to facilitate a variety of printing applications such as telematics system support and on-site printing from a portable personal computer.

### BACKGROUND OF THE INVENTION

Vehicle telematics system; which combine telecommunications equipment with on-board and remote computers to facilitate operation and use of a vehicle, are gaining in popularity. One known type of vehicle telematics system uses an in-vehicle computer, a global positioning satellite (GPS) transceiver, and a wireless communication system for automatic roadside assistance and remote vehicle locating and diagnostics. Such vehicle telematics systems are commercially available. For example, the OnStar Corporation of Troy, Mich., which is a wholly-owned subsidiary of the General Motors Corporation, sells such a system under the trademark ONSTAR.

Most of the communication between the passenger and the existing telematics system is transmitted audibly, usually using a microphone in the vehicle and the speakers of the vehicle's sound system. In practice, this audible-only form of communication is inefficient and time consuming for performing some functions For example, if a vehicle occupant would like directions to a particular location, they activate the telematics system to contact a remote fixed center, usually through a wireless communication system component of the telematics system, such as a cell phone. An operator receives the call from the vehicle along with appropriate positioning information from the vehicle through the GPS technology component of the telematics system. The operator then compares the location of the vehicle with the desired location of the driver and then provides the driving directions to the vehicle occupant by speaking to the occupant over the cell phone. The occupant then must remember each step of the directions, or write them down as they are audibly provided to him by the operator. Accordingly, the vehicle occupant often forgets the provided directions, or worse when the vehicle occupant is the driver, he may be distracted while driving by attempting to write down the information provided by the operator.

In addition to the current features offered by vehicle telematics systems, new generation vehicle telematics systems are being developed that allow vehicle occupants to maintain further contact with their fixed computing and communication systems while on the road. For example, these new generation vehicle telematics systems will allow vehicle occupants to send and receive email and browse a world wide computing network, such as the Internet, while traveling in the vehicle. However, the current audio-only form of communication between the vehicle occupants and the telematics system, severely limits the usefulness of these additional features. For example, few vehicle occupants would welcome having a remote operator read the vehicle occupant's personal email to them over the cell phone component of the telematics system. Similarly, information found by the vehicle occupant while searching a worldwide computing network is difficult to retrieve and comprehend using only audio input.

To date, printer use in vehicles has focused primarily on making the printers portable to support laptop computer operations. For example, U.S. Pat. No. 6,273,310 to Gregory discloses a portable arm rest-type console for receiving a laptop computer and printer therein. The console is designed so that a driver can operate the laptop computer, and print materials from the computer as needed while driving. The console itself is detachably secured to the vehicle and occupies at least one seat in the vehicle. The printer is slidably received within the console such that to operate the printer, the user must open an access door in the console and slide the printer over the front, right passenger seat of the vehicle. The console also includes carrying straps for moving the console from place to place. Similar structures are disclosed in U.S. Pat. No. 5,966,285 to Demtchouk and U.S. Pat. No. 6,135,546, both of which provide removable computer workstations that rest on vehicle seats.

These types of detachable computer workstations have several limitations. For example, they are bulky, heavy, and relatively expensive. They also occupy at least one seat in the vehicle, thereby reducing the seating capacity of the vehicle, and they do not improve the communication between the vehicle's occupants and the vehicle's telematics system.

### SUMMARY OF THE INVENTION

Accordingly, despite the known use of printers in vehicles, there remains a need for an in-vehicle printing system that provides an in-vehicle mounted printer operably connected to a host-computing device, such as the vehicle's telematics system or a personal computer. Preferably, that printer is secured within the vehicle such that it does not reduce the available seating capacity of the vehicle and it is concealed when not in use. In addition to other benefits that will become apparent in the following disclosure, the present invention fulfills these needs.

The present invention is an in-vehicle printing system that provides a printer operably secured and concealed within an existing component of the vehicle, such as the front passenger seat. The printer is preferably in communication with the vehicle's telematics system.

### BRIEF DESCRIPTION OF THE DRAWINGS

FIG. 1 is a partial, isometric view of a vehicle having a seat therein containing a printer in accordance with an embodiment of the present invention.

FIG. 2 is an isometric view of the printer of FIG. 1.

FIG. 3 is an enlarged back, plan view of the vehicle seat of FIG. 1.

FIG. 4 is a side view of the seat of FIG. 2 showing a possible orientation of the printer therein.

FIG. 5 is a side view of the seat of FIG. 2 showing an alternative possible orientation of the printer.

FIG. 6 is a block diagram of an in-vehicle printing system in accordance with an embodiment of the present invention.

### DETAILED DESCRIPTION

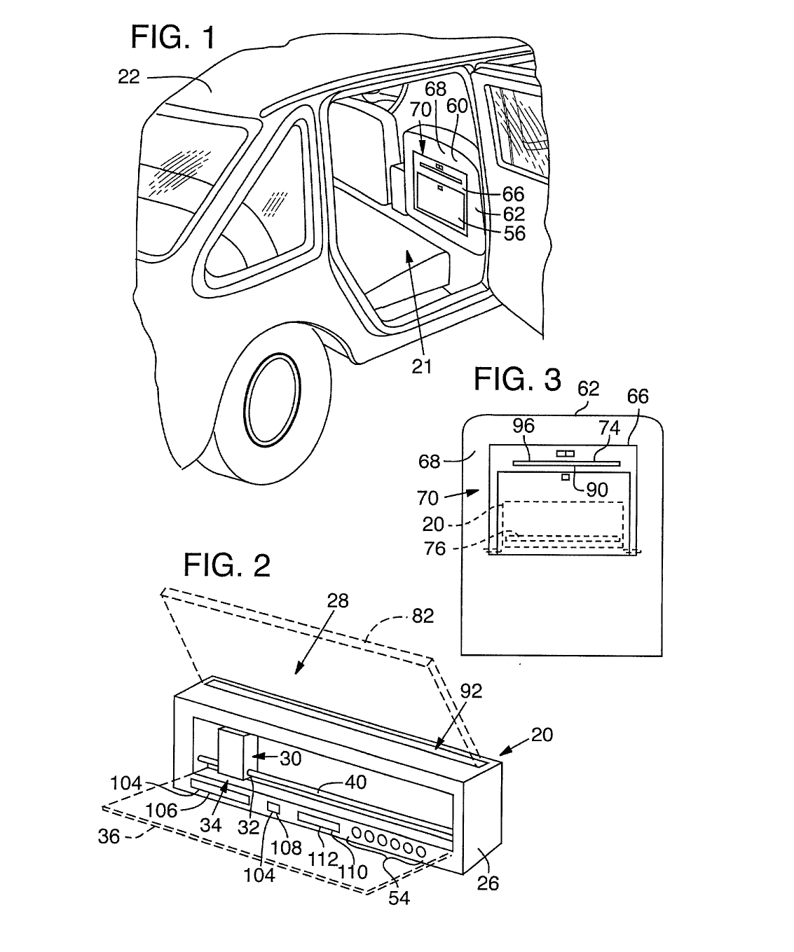

An in-vehicle printing system 18 (FIG. 6) having a printer 20 operably secured in a vehicle 22 and operably connected to the vehicle's telematics system 24 and/or a personal computer 52 is disclosed in FIGS. 1-6.

A. Printer Assembly

The printer 20 is preferably a conventional printer that has been adapted for installation in the vehicle. One known type of printer 20 having the overall dimensions to be readily secured within a vehicle as described is an inkjet printer manufactured and sold by the Hewlett-Packard Corporation of Palo Alto, Calif. under the trademark HP DESKJET 350C. The inkjet printer 20, shown in FIG. 2, includes a chassis 26, a print medium handling system 28 for supplying sheets of print media to the printer 20, and a movable print carriage 30 for moving one or more printheads 32 relative to the print medium at a print zone 34. The print media may be any type of suitable sheet material, such as paper, card-stock, transparencies, mylar, foils, and the like, but for convenience, the illustrated embodiment is described using paper as the print medium. The print medium handling system 28 moves the print media into the print zone 34 from a feed tray 35 to an output tray 36, for instance, using a series of conventional motor-driven rollers (not shown).

In the print zone 34, the media sheets receive ink from a printhead 32. Each printhead 32 has bottom surface comprising an orifice plate with a plurality of nozzles formed therethrough in a manner well known to those skilled in the art. The illustrated printheads 32 are thermal inkjet printheads, although other types of printheads may be used, such as piezoelectric printheads. The printheads 32 typically include a plurality of resistors that are associated with the nozzles. Upon energizing a selected resistor, a bubble of gas is formed ejecting a droplet of ink from the nozzle and onto a sheet of paper in the print zone 34 under the nozzle.

The printheads 32 are transported by the carriage 30, which may be driven by a conventional drive belt/pulley and motor arrangement (not shown) along a guide rod 40. The guide rod 40 defines a scanning direction or scanning axis along which the printheads 32 traverse over the print zone 34. The printheads 32 selectively deposit one or more ink droplets on a print media page located in the print zone 34 in accordance with instructions received via a conductor strip from a printer controller (not shown), such as a microprocessor which may be located within chassis 26. The controller may receive an instruction signal from a host device 50 (FIG. 6), which is typically a computer, such as a personal computer 52. Preferably, the host device 50 also includes the vehicle's telematics system 24.

The printhead 38 carriage motor (not shown) and the print medium handling system 28 drive motor (not shown) operate in response to the printer controller, which may operate in a manner well known to those skilled in the art. The printer controller may also operate in response to user inputs provided through a keypad 54 (FIG. 2). A monitor 56 coupled to the host computer may be used to display visual information to an operator, such as the printer status or a particular program being run on the computer. Personal computers, their input devices, such as a keyboard and/or a mouse device, and monitors are all well known to those skilled in the art.

B. Printer Mounting

The printer 20 is preferably secured within the passenger compartment 21 of the vehicle 22 such that it does not reduce the available seating capacity of the vehicle 22 and it is concealed when not in use. More preferably, the printer 20 is positioned in the vehicle so as not to distract the driver of the vehicle 22 while driving.

Accordingly, a particularly desirable location for mounting the printer is within a passenger seat 60. More preferably, as best shown in FIGS. 1, and 3-5, the printer 20 is mounted in the seat back 62 of the front passenger seat 60 of the vehicle 22 so that the printed material is expelled from the back 68 of the front passenger seat 60.

The seat back 62 preferably includes a chamber 64 sized to receive the printer 20 and feed tray 35. The chamber 64 includes a latchable, access door 66 that is preferably pivotally secured to the passenger seat 60 thereby defining a closed position 70 shown in FIGS. 1, 3, and 4, and an open position 72 shown in FIG. 5. As best shown in FIG. 1, all available seats in the vehicle are available and unblocked when the access door 66 is in its closed position 70.

The back 68 of the passenger seat 60 includes an inlet slot 74 for receiving paper into the feed tray 35, and an exit slot 76 for allowing printed paper to be expelled from the chamber 64 after passing through the printer 20. With the access door 66 in its closed position 70, a paper path is defined by arrows 78 such that sheets of paper travel through the inlet slot 74 to the feed tray 35, where it then travels through the printer 20 and out the exit slot 76.

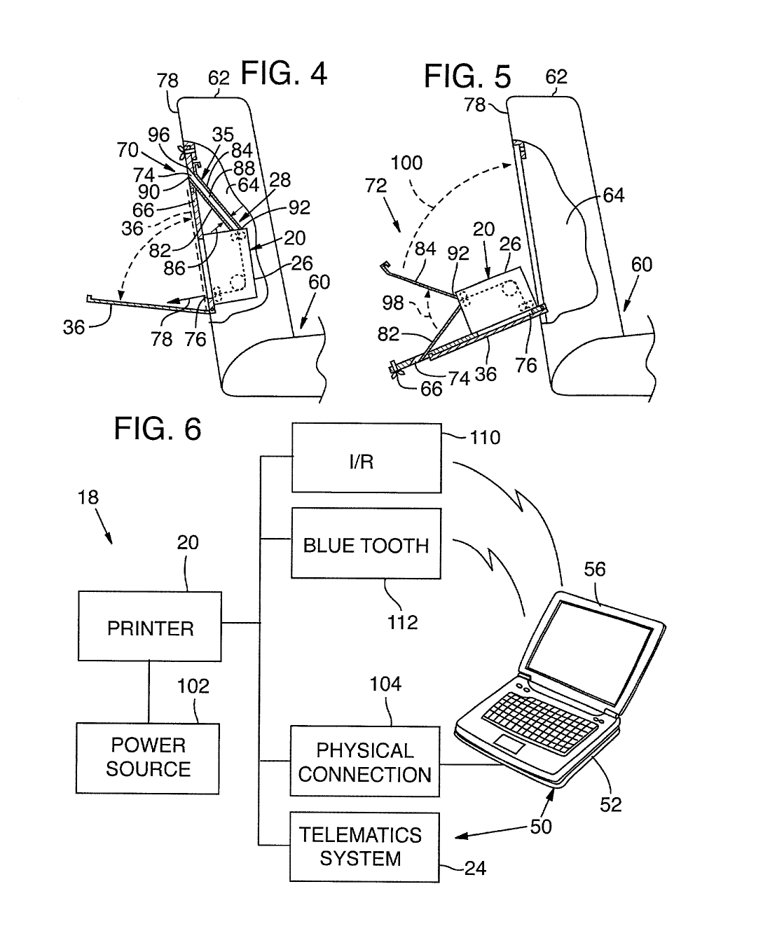

The output tray 36 is preferably secured to the access door 66, adjacent to the exit slot 76 for compiling and neatly storing printed paper expelled through the exit slot 76 from the printer 20. More preferably, this output tray 36 is pivotally secured to the access door 66 such that it may pivot out of the way when not in use as shown in broken lines in FIG. 4.

Preferably, the printer 20 is operably secured to the access door 66 such that the internal printer components are easily accessible when the access door 66 is in its open position 72 as shown in FIG. 5. Alternatively, the printer 20 may be secured to the passenger seat 60 within the chamber 64, with access to the printer components being provided by separate access door (not shown) in the chassis 26. Vibration isolators (not shown) preferably extend between the printer 20 and chamber to help isolate the printer 20 from vibrations while the vehicle 22 travels.

Similarly, the feed tray 35 is preferably easily accessible when the access door 66 is in its open position 72, thereby allowing paper jams and like in the feed tray 35 to be easily cleared. One known way to provide an easy access feed tray 35 is shown in FIGS. 4 and 5. As best shown in FIG. 4, the feed tray 35 preferably includes a forward panel 82 and a rearward panel 84 that are spaced apart from each other and aligned substantially parallel with each other when the access door 66 is placed in its closed position 70. The distance 86 between the two panels 82, 84 defines a storage area 88 for receiving a stack of sheets of paper, said sheets being fed one at a time to the printer 20 using known technology.

The forward panel 82 extends from the lower lip 90 of the inlet slot 74 in the access door 66 to the inlet portion 92 of the printer. When the access door 66 is in its closed position 70, the rearward panel 84 extends from the upper lip 96 of the inlet slot 74 in the access door 66 to the inlet portion 92 of the printer 20 as shown in FIG. 4. The rearward panel 84 is preferably pivotally secured to the printer 20 and biased to a position away from the access door 66 such that when the access door is in its open position 72, the rearward panel 84 pivots away from the forward panel 82 in the direction of arrow 98 (FIG. 5) thereby providing easy access to the feed tray 35. It can be appreciated by one skilled in the art, that moving the access door 66 to its closed position 70 urges the rearward panel 84 of the feed tray 35 in the direction of arrow 100 (FIG. 5) to contact the passenger seat 60 as shown, thereby ultimately positioning the forward and rearward panels 82, 84 substantially parallel with each other as shown in FIG. 4 and defining the feed tray 35 as previously described.

C. Printer Communication

FIG. 6 shows an exemplar block diagram of the printer 20 being connected to a plurality of host devices 50 including a personal computer 52 and the vehicle's telematics system 24.

Preferably, the printer 20 is in electrical communication with an existing power source 102 on the vehicle 22, such as the vehicles' battery or electrical system. The preferred location of the printer 20 in the front passenger seat 60 allows the printer 20 to be easily connected to an existing power source 102, such as power lines typically running to the passenger seat 60 to power electrical seat movement actuators (not shown) or seat heaters (not shown) imbedded within the passenger seat 60.

The vehicle's telematics system 24 is known in the art. One known type of vehicle telematics system uses automobile systems, a global positioning satellite (GPS) technology, and other wireless communication systems for automatic roadside assistance and remote vehicle locating and diagnostics. One known functioning vehicle telematics system is sold by the OnStar Corporation of Troy, Mich. under the trademark ONSTAR.

Placing the printer 20 in communication with the vehicle's telematics system 24 allows a variety of information to be printed for the vehicle occupant's convenience. For example, vehicle occupants can receive facsimile transmission, print pages of information displayed on a world-wide network, such as the Internet, and print their e-mail while traveling in the vehicle. Similarly, current information provided by the vehicle telematics system 24, such as driving directions, reservation numbers, and the like, may now be sent by a remote operator to the printer 20, thereby allowing the vehicle occupants to print out and read this information more efficiently than attempting to remember it or write it down while driving. Moreover, as the variety of information available to vehicle occupants through vehicle telematics systems increases, the printer 20 will facilitate vehicle occupant's access to and retention of this information.

Preferably, the printer also includes at least one port 104 to detachably secure an auxiliary computing device, such as a personal computer 52, handheld computer (not shown), digital camera (not shown), scanner (not shown), or the like. This port 104 can be a physical connection, such as a printer jack 106 or Universal Serial Bus (“USB”) 108 port, or it can be a wireless port, such as a conventional infrared port 110 or other wireless technology 112, such as the wireless technology currently sold by a variety of manufacturers under the collective trade name BLUE TOOTH. In such case, the auxiliary computer device would include appropriately compatible wireless transmitters and receivers to communicate through the corresponding wireless port connected to the printer 20. In addition, the location of these components within the vehicle can be optimized for the particular auxiliary computing device. For example, the wireless receive can be located within the vehicle dashboard or the like to facilitate connection of an auxiliary computer device while being held by a vehicle occupant in the front seats of the vehicle. Accordingly, the on-board printer can also be used as a conventional printer to support conventional personal computing, scanning, and digital photograph printing operations.

E. Alternative Embodiments

Even though the foregoing description has focused on the installation and operation of an inkjet printer, it can be appreciated that the basic concepts of this invention will work equally well with any other type of printer and associated print-medium installed in the vehicle. Similarly, there need not be a physical connection between the vehicle's telematics system and the printer. Appropriate wireless communications, such as the disclosed infrared (IR) and BLUE TOOTH technologies, could be applied to transmit information between the printer and vehicle telematics system.

Thus, having here described preferred embodiments of the present invention, it is anticipated that other modifications may be made thereto within the scope of the invention by individuals skilled in the art. Thus, although preferred and alternative embodiments of the present invention have been described, it will be appreciated that the spirit and scope of the invention is not limited to those embodiments, but extend to the various modifications and equivalents as defined in the appended claims.

What is claimed is:

1. An in-vehicle information printing system for an occupant in a vehicle comprising:
a printer operably received within the vehicle; and,
a telematics system providing information to the occupant, said telematics system serving as a host device for commanding the printer;
such that said information from the telematics system may be printed on a print medium operably connected to the printer to thereby allow the vehicle occupant to display said information in printed format.

2. The in-vehicle information printing system for an occupant in a vehicle of claim 1, wherein said information is wirelessly provided to the vehicle from a remote location.

3. The in-vehicle information printing system for an occupant in a vehicle of claim 1, wherein said printer is operably secured within a passenger compartment of the vehicle.

4. The in-vehicle information printing system for an occupant in a vehicle of claim 3, wherein said printer is secured within a passenger seat of the vehicle, said passenger seat has a seating area, and said printer does not occupy any portion of said seating area.

5. The in-vehicle information printing system for an occupant in a vehicle of claim 4, wherein said passenger seat has a seat back and a back side, wherein said printer is operably received within a chamber in said seat back and is accessible through said back side of said seat back.

6. The in-vehicle information printing system for an occupant in a vehicle of claim 1, wherein said printer includes a port for operably connecting a personal computer, and said personal computer serves as a second host device for commanding the printer.

7. The in-vehicle information printing system for an occupant in a vehicle of claim 6, wherein said port for operably connecting the personal computer is wireless.

8. A method for displaying information from a telematics system, the telematics system able to wirelessly transmit information from a remote location to the vehicle, the vehicle having a passenger compartment with a plurality of passenger seats therein, each said passenger seat having a seating area, said method for displaying information comprising the steps of:
securing a printer within the passenger compartment such that the seating area of each passenger seat within the vehicle is not blocked by any portion of the printer;
operably connecting the telematics system to the printer;
receiving information through the telematics system;
printing the information on a print medium operably secured to the in-vehicle printer.

9. The method for displaying information in a vehicle of claim 8, further including the step of operably connecting an auxiliary host device to the printer.

10. An in-vehicle printer comprising:
a printer operably connected to a host device, said host device commanding the printer; and,
a vehicle having a chamber for receiving said printer and a passenger seat therein, said passenger seat having a passenger seating area;
wherein said printer is operably secured within said chamber such that said printer does not occupying any portion of said seating area.

11. The in-vehicle printer of claim 10, wherein said host device is a vehicle telematics system.

12. The in-vehicle printer of claim 10, wherein said host device is a portable computer.

13. The in-vehicle printer of claim 10, wherein said chamber is received within said passenger seat.

14. The in-vehicle printer of claim 13, wherein said passenger seat has a seat back, and said chamber is received within said seat back.

15. The in-vehicle printer of claim 14, wherein said seatback includes an inlet slot and an exit slot and a print medium may be inserted through said inlet slot such that said print medium travels through said inlet slot to said printer, and from said printer through said exit slot.

16. The in-vehicle printer of claim 14, wherein said passenger seat has a back side and said chamber is accessible through an access door on said back side, said access door is pivotally secured to said seat back to define a closed position and an open position.

17. The in-vehicle printer of claim 16, further including a feed tray extending between said access door and said printer when said access door is in said closed position.

18. The in-vehicle printer of claim 17, wherein said feed tray includes a forward panel and a rearward panel spaced apart from each other by a defined distance to define an area for receiving a stack of print medium when said access door is in said closed position.

19. The in-vehicle printer of claim 18, wherein said rearward panel is pivotally secured to said printer and biased to a position away from said access door such that said area for receiving a stack of print medium is accessible when said access door is in said open position.

20. The in-vehicle printer of claim 14, further including an output tray pivotally secured to said seat back.
